(19) United States
(12) Patent Application Publication
(10) Pub. No.: US 2008/0162900 A1
(43) Pub. Date: Jul. 3, 2008

(54) System, Method and Apparatus for Observing a Control Device

(76) Inventors: Andre Rolfsmeier, Bad Lippspringe (DE); Marc-Andre Dressler, Bahnhofstr (DE); Horn Hans-Gunter Limberg, Paderborn (DE)

Correspondence Address: CHADBOURNE & PARKE LLP, 30 ROCKEFELLER PLAZA, NEW YORK, NY, 10112, US

(21) Appl. No.: 11/618,609

(22) Filed: Dec. 29, 2006

(51) Int. Cl. G06F 15/00

(52) U.S. Cl. 712/227

(57) ABSTRACT

The invention concerns a process for the monitoring of a control device by means of a processing unit, whereby the control device comprises at least one micro-controller, at least one storage unit and at least one debugging interface, such that the storage unit features address contents in addresses within its address space, and such that the debugging interface is outfitted with a trace functionality for the observation of monitoring addresses within at least one trace address area inside the address space.

This aspect of the current invention is carried out for example in that a monitoring service is installed on the control device for execution by way of the micro-controller, that upon the control device is provided at least one separate trace address area within the address space with at least one address that the monitoring service receives communication of divided monitoring addresses, for example, within the address space and that the monitoring service copies the address contents of at least a portion of the monitoring addresses sequentially onto at least one address of the trace address area.

The invention concerns a process for the monitoring of a control device by way of a processing unit, whereby the control device comprises at least one micro-controller, at least one storage unit and at least one debugging interface, the storage unit features address contents in addresses within an address space and the debugging interface is outfitted with a trace functionality for the control of monitoring addresses within at least one trace address area inside the address space.

Processes of the described kind are known in practice and find use above all in applied research and industrial development wherever control units are developed, tested and placed into use.

The term control device is understood herein to comprise any and all electronic devices with the aid of which are processed technical and physical processes. Customarily such a control device comprises at least one computer unit, for example in the form of a processor or micro-controller, a storage unit as well as input/output interfaces in order to make it feasible to perform calculations as a function of internally stored parameters and/or internal calculating magnitudes and/or preset magnitudes—in any event supplied by external sources, and in order to be equally able to interact upon external processes by generating electronic signals. For purposes of control technology, such control units work not only as simple controllers, but are especially also suited to solve complex control tasks. In the following discussion, whenever reference is made to control devices, controllers and control processes, these invariably also comprise devices and activities consistent with the aforesaid more general definition.

In the following discussion, the term micro-controllers is understood to comprise electronic computer units with an associated electronic storage, regardless whether the storage unit is completely or partly incorporated as a component of the computer unit or whether the computer unit and its associated storage device constitute separate components.

What the monitoring of a control unit by way of a processing unit accomplishes is explained in the following illustration of the development process which the control units undergo in practice, at least within the framework of more extensive tasking functions.

At the outset of a control technology tasking function lies first of all the mathematical modeling and simulation of a technical and physical process to which is to be imparted a desired dynamic property. On the strength of the resulting abstract mathematical models it is possible to test different control concepts present also exclusively as mathematical model concepts within the framework of numeric simulations; this step constitutes the modeling phase and computer design, mostly on the basis of computer-assisted modeling tools.

In the next step, the controller designed in the mathematical model is transferred onto a real-time simulation unit, mostly far exceeding in its computing performance as well as in its I/O (input/output) capabilities the customary serial control device, interacting with the true physical process. Inasmuch as the transfer of the abstract-formulated control unit from a modeling tool onto the simulation unit is largely automated, this second phase is known as RCP (rapid-control prototyping) or function prototyping.

If the control technology problem is solved by the simulation unit-driven control device, the control algorithm is transferred within the framework of the control device implementation—mostly in a fully automated step—onto the ultimate (serial) control unit to be utilized in practice.

The control unit now basically usable in the actual process is frequently subjected prior to use to a test in which the actual process is ultimately designed to interact with the control device, partly or wholly simulated by a real-time simulation unit and the control unit is simulated by way of the signal testing pattern (the hardware-in-the-loop simulation). So tested, the control unit is ultimately employed in the actual process and operated interacting with it.

Notwithstanding the extensive preliminary tests, it is mostly necessary to undertake adjustments on the control unit and/or the functions implemented in the control unit. To this end it is on the one hand necessary to be able to monitor, record and analyze concurrently the status of the control device, in other words all input and output data as well as those applied internally. On the other hand, it is necessary by way of written access to be able to modify on the storage unit of the control device, the parameters and/or parameter sets underlying the function/control algorithms, in other words codes, lines or fields. These described processes are collectively designated as control-unit application.

German patent DE 10 2004 027 033 A1 describes different processes for the adjustment and monitoring of a control unit, along with technologic prerequisites which actually make it possible to monitor and interact with a control device by way of an interactive device. Also, there is described here a process for the monitoring of control units outfitted with micro-controllers which feature a debugging interface. Such interfaces are in part standardized, as for example in the NEXUS Standard (IEEE-ISTO 5001: “The NEXUS 5001 Forum Standard for a Global Embedded Processor Debug Interface”, 2003).

Debugging interfaces afford far-reaching possibilities for the observation and processing of conditions of the control unit micro-controllers, affording lag-time observation and control (debugging) of the micro-controller, thus in particular the monitoring of the program code execution and the data accessed and modified thereby. Inasmuch as the debug interfaces are an integral port of the micro-controller hardware, they lend themselves to far faster access to the micro-controller than would be feasible with a software-based communication interface.

In the process for the monitoring of a control unit as per German Patent DE 10 204 (sic) 027 033, use is made of a bidirectional channel of the debug interface for the purpose of transferring data from the interactive unit onto the control unit, and vice-versa, for the transfer of data previously requisitioned by the processing unit from the control unit onto the processing unit, whereby such data are the address content in addresses within the address space stored in the storage unit of the control device. The utilization of one of these bidirectional interfaces for the monitoring of the control unit has the advantage that the control unit itself need not possess any knowledge of the monitoring addresses, inasmuch as a read-out of such monitoring addresses is at all times newly requisitioned externally from the processing unit upon repeat specification of the processing addresses.

Effective micro-controllers outfitted with a debug interface are for example micro-controllers from the MPC 55xx family of Freescale Semiconductor Inc. For the conversion of the described functionality, use is for example made of the JTAG port of the processor when utilizing MPC 5553 or MPC 5554 (JTAG refers to the IEEE standard 1149.1 elaborated by the Joint Test Action Group, describing a process for the debugging of electronic hardware. True, the functionality embedded in the ]TAG interface is well suited to the monitoring and processing of a control device by way of a processing unit, but the interface is often not up to demanding monitoring and processing tasks, for the reason that the transfer rates achievable by it are too limited.

Along with the JTAG interface, the debug interfaces of certain micro-processors and/or micro-controllers feature an additional interface within the debugging interface, which lends itself for use by way of a so-called trace functionality of the debugging interface. The trace functionality affords the possibility to monitor automatically an entire address area—the trace address area—within the address space of the control unit and/or the storage unit of the control device. To this end, the trace address area is preloaded onto the micro-controller of the control unit, whereby the trace functionality sees to it that any alteration of the content of an address within the trace address area is immediately communicated by way of the debug interface. In the case of the micro-controllers MPC 5553 and MPC 5554, referred to only by way of an example, this is accomplished by way of an interface capable of very high data rates, to wit the auxiliary port and/or the MDO pins (Message Data Out) of the auxiliary output ports.

Nevertheless, at the present state of the art, trace functionality is not employed for the monitoring of a control device within the meaning of this invention, for the reason that the micro-controllers outfitted with trace functionality can often be preloaded with just one single trace address area or just a few trace address areas. For example, if a single trace address area is to be used to check monitoring addresses extending over a wide range in the address space of the control unit, the trace functionality will automatically monitor all other addresses of no interest among the monitoring addresses and will also capture and display by way of trace functionality changes in the content of addresses of no interest. This property makes the use of trace functionality for the monitoring of a control unit, above all under real-time conditions and with the lowest possible distortion of the lag-time conduct of the control unit by reason of the monitoring, of little interest.

The task of the within invention is to avoid, at least in part, the described drawbacks of known processes for the monitoring of a control device with the use of the trace functionality of a debugging interface.

According to the invention, the indicated task is firstly and substantially solved with the process discussed here by arranging on the control device monitoring service operated by the micro-controller, by defining on the control device at least one separate trace address area within the address space with at least one address, by communicating to the monitoring service—notably divided—monitoring addresses within the address space, and by having the monitoring service copy sequentially the address content—of at least a portion—of the monitoring addresses in at least one address of the trace address area.

The concept of arranging a monitoring service on the control device is understood to mean that one supplemental program—the monitoring service—is executed on the control device by the micro-controller, specifically in addition to the programs to be executed by the control device and/or the micro-controller of the control device, by which the control device is enabled to carry out its original functions (measuring, controlling, regulating).

The concept of defining a separate trace address area within the address space of the control device and/or the micro-controller of the control device is understood to mean presetting an address area which specifically does not, nor does it need to, comprise the monitoring addresses of interest, and instead may even comprise merely one single address, whereby such single address may be understood to mean a trace channel. At this point, the monitoring address of actual interest within the address space may be communicated to the monitoring service, whereby the task central to the monitoring service consists in copying the address contents of the monitoring addresses sequentially—that is, consecutively in time—onto at least one address of the trace address area. By presetting the separate trace address area, the preset trace functionality of the control device and/or the micro-controller of the control device automatically intervenes, the moment the content of the address within the trace address area changes.

By means of the process arranged according to the invention and the provision of a monitoring service on the control device, it is possible to monitor with one trace address area, which in the simplest case may comprise just one single address, any number at will of the monitoring addresses of interest within the address space of the storage unit of the control device, whereby the output of the address content of one monitoring address may be performed by the trace functionality anyway available on the micro-controller. By the same token, an address and/or any address within the trace address area may also be conceived of as a trace channel, inasmuch as each address within the trace address area acts thanks to the monitoring by way of the available trace functionality just as a transmission channel for the contents of the monitoring addresses, copied onto the address of the trace address area.

Surprisingly, the process according to the invention affords a further advantage vis-à-vis the “customary” utilization of trace functionality, primarily in regard to the initialization of the control device monitoring. Where the “customary” trace functionality is employed, the monitor remains in doubt as to the original content of the monitoring addresses, since it first acquires knowledge of the address contents of the monitoring addresses after the same have been initially altered. Conversely, in the process according to the invention, the active modification of the address content of an address within the trace address area also elicits an initial communication of the address content of the monitoring addresses.

In a preferred embodiment of the invented process, the monitoring service embedded in the micro-controller of the control device receives from the processor unit communication of the monitoring addresses within the address space. Customarily, processor units feature one additional interface, that is, a user interface over which the user can configure the processor and over which the user can also read out the address contents of the monitoring addresses within the address space of the control device storage unit.

A further preferred embodiment of the invention is characterized in that the monitoring addresses of the address contents sequentially transmitted to the processing unit by way of the address of the trace address area can be detected by the processing unit as a function of the transmission sequence. A prerequisite of this embodiment of the invention is that the processing unit has knowledge of the sequence in which the monitoring unit copies the address contents of the monitoring addresses into an address of the trace address area (the trace channel). The sequence of the address contents of the monitoring addresses transmitted by the monitoring service by way of the trace channel encodes then the monitoring address of the particular address content so received, whereby every datum so received by the processing unit can be subordinated to one monitoring address.

A further especially preferred embodiment of the invention provides that in addition to the address content of a monitoring address, the monitoring address itself is copied onto an address in the trace address area; that is to say, the content of one monitoring address and the monitoring address itself are copied jointly by the monitoring service and transmitted from the trace functionality onto the processing unit. In a variant of the preferred exemplified embodiment, this is accomplished in that the address content of the monitoring address and the monitoring address itself are consolidated into a single datum of a correspondingly greater magnitude than the mere address content of a monitoring address. Consequently, for the implementation of this variant, provision must be made for a superimposed protocol which executes the consolidation of the monitoring address and the contents of the monitoring address on the control device on the one hand and the separation of both items of information from the one information transmitted by way of the trace functionality in the monitoring address and its content, upon the processing unit. In this conjunction, the superimposed protocol may simply be preset by free scalability of the trace channel—in other words, the magnitude of the address in the trace address area, or else the superimposed protocol may also be simply realized by having the separate trace address area comprise two addresses and thereby two trace channels, whereby the monitoring address is, for example, transmitted over one trace channel and the content of the monitoring address of the trace functionality is transmitted over the other trace channel.

In an especially preferred embodiment of the process according to the invention, provision is made for at least one control instruction for the control of the processing unit by way of at least one address of the trace address area, whereby the control instruction is encoded by the value of the transmitted datum. Thanks to this property, it is for example possible in a very simple manner to have the monitoring service exert influence on the processing unit and by having, for example, the processing unit synchronized with the monitoring process on the control device. According to an especially advantageous further development of this embodiment of the process, provision is made for a control instruction to indicate to the processing unit the start and/or the end of the transmittal of the address content of at least one processing address, whereby the control instruction preferentially indicates the start and/or the end of the transmission of sequentially transmitted address contents of several processing addresses. This ensures in a very simple way and manner that in the presence of a continuous stream of data from the address contents of the monitoring addresses from the control unit onto the processing unit, the processing unit is capable of clearly recognizing the start and/or the end of a monitoring cycle, thereby preventing the chance that an “out-of-step” sequence of transmitted address contents of the monitoring addresses to the monitoring addresses in the processing unit be erroneously continued.

Beyond that, the process according to the invention affords the possibility of monitoring the address contents of the monitoring addresses in a fixed time frame, which is not feasible with the conventional utilization of the trace functionality, for the reason that the conventional trace functionality of the debugging interface is event-driven. For this reason, provision is made in a preferred embodiment of the invented process for the monitoring service to copy the address contents of the monitoring addresses in a fixed time frame sequentially onto at least one address of the trace address area.

In much the same way it is also possible additionally or alternatively in a further preferred embodiment of the process for the monitoring service to copy upon direction of the processing unit the address contents of the monitoring addresses in the address—the trace channel—whereupon the available trace functionality sees to it that the data copied onto the address in the trace address area be made available by way of the debug interface utilized by the trace functionality and/or the portion of the debug interface utilized by the trace functionality.

In a further preferred embodiment of the invented process, the monitoring service copies the address contents of the monitoring addresses, utilized for different tasks performed on the control unit, onto different addresses and/or trace channels of the trace address area. In this respect, it is immaterial whether the task in the context utilized here represents a process or a thread; rather, the tasks here should be conceived of as differentiated program technology processes, whereby the tasks may for example be differentiated by being computed at a differential sampling rate. Thanks to the described embodiment of the invented process, it is possible in a simple way to monitor the address contents of the monitoring addresses of interest separately and well differentiated the one from the others within different tasks.

More particularly, we have here a number of possibilities to devise and further develop the transmitting and receiving features according to the invention. In this regard, reference is made on the one hand to the patent claims next following claim 1, and on the other hand to the following description of exemplified embodiments in conjunction with the drawing. The drawing shows:

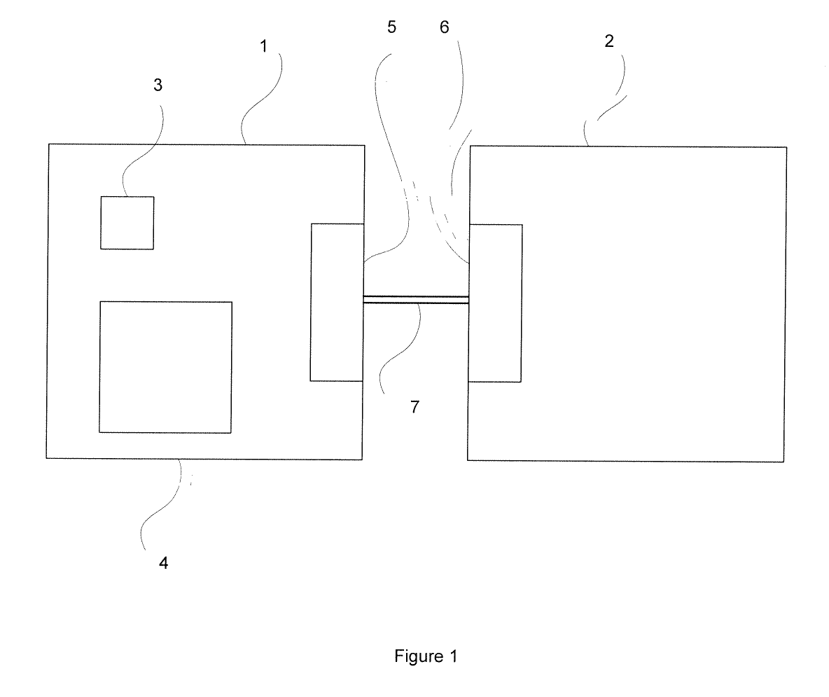

FIG. 1 a monitoring system known in prior art, consisting of a control device and a processing unit connected with each other,

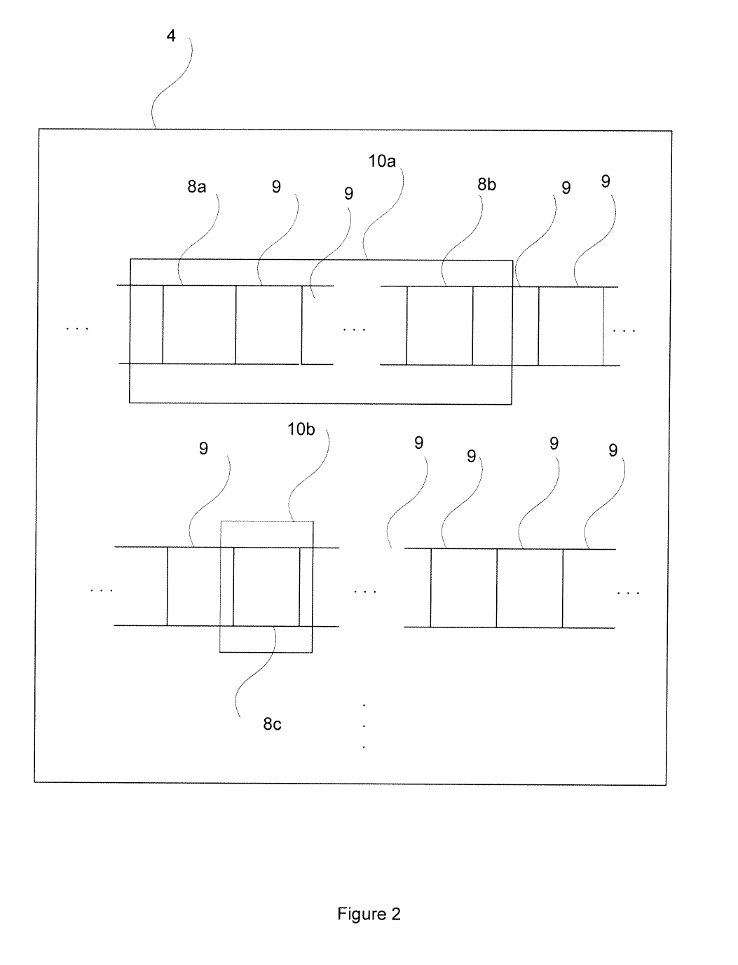

FIG. 2 a schematic representation of the storage unit of the control device with monitoring addresses of interest and the arrangement of trace address areas according to a monitoring process known in prior art.

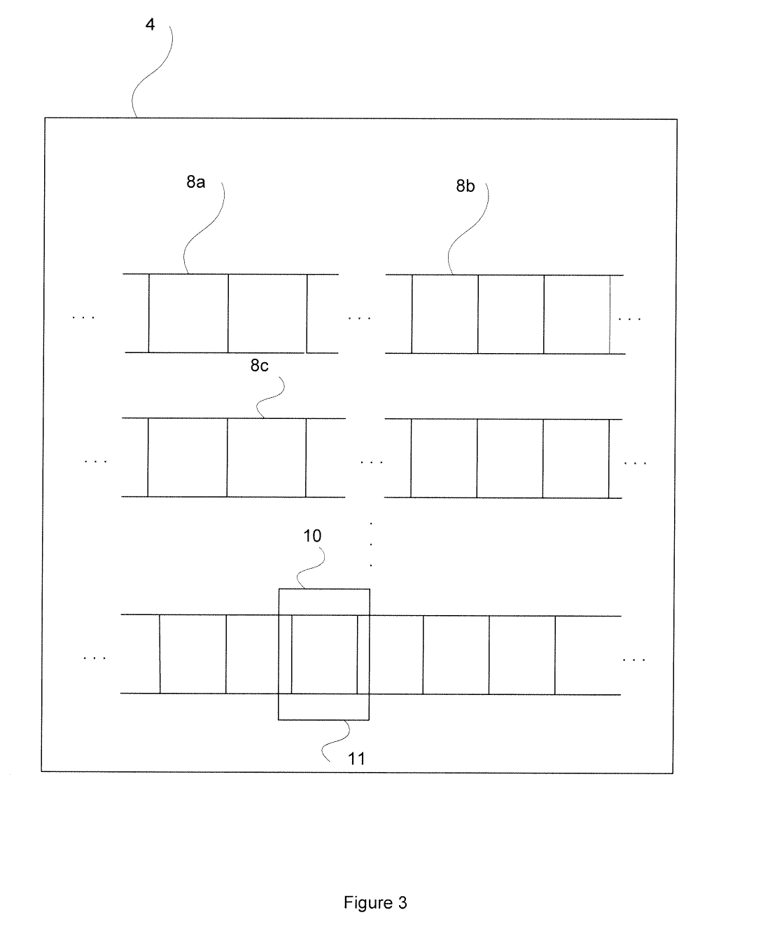

FIG. 3 a schematic representation of the storage unit of the control device and the employment of a separate trace address area according to the invention, for the monitoring of the control device, and

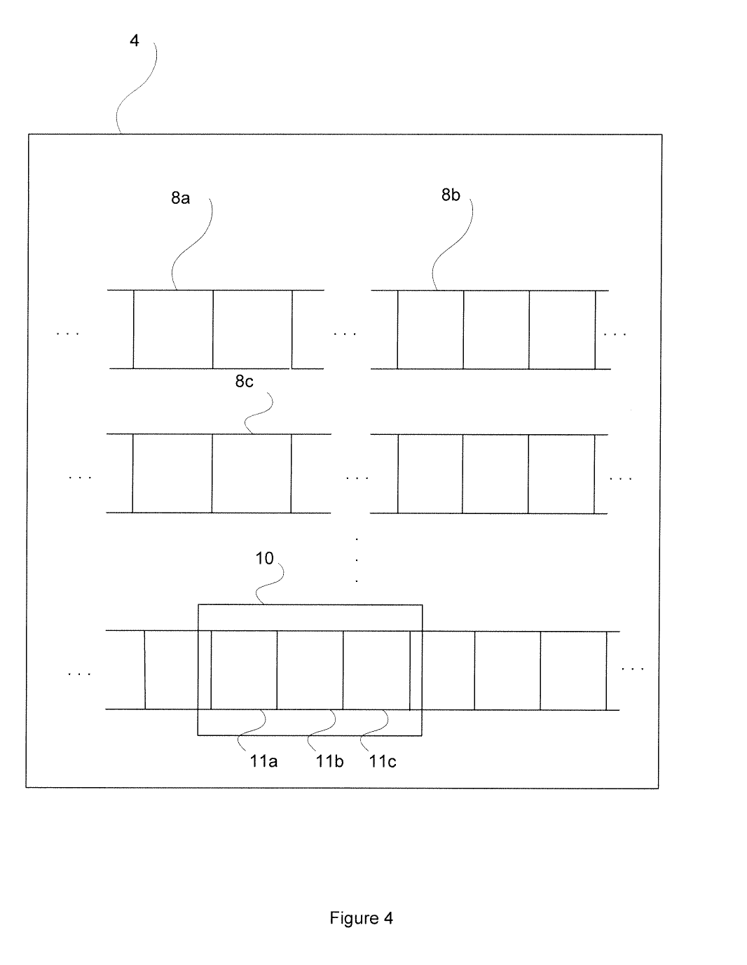

FIG. 4 a further schematic representation of the storage unit of the control device with a further exemplified embodiment of a separate trace address area utilized in conformity with the invention.

FIG. 1 illustrates the technologic prerequisites for the execution of the invented process for the monitoring of a control device 1 by a processing unit 2, whereby the control device 1 comprises at least one micro-controller 3, at least one storage unit 4 and at least one debugging interface 5. The processing unit 2 likewise features a debugging interface 6 corresponding to the debugging interface 5 of the control device 1. The control device 1 and the processing unit 2 are interconnected by way of a suitable connection 7 over the debugging interface 5 of the control device and the debugging interface 6 of the processing unit. As a rule, the connection 7 between the control device I and the processing unit 2 consists of a plurality of different electric connection links, depending on the type of debugging interface 5 of the control device 1 and the debugging interface 6 of the processing unit 2.

In the exemplified embodiment illustrated in FIG. 1, the debug interface 5 is comprised in the micro-controller 3, even though the debug interface 5 and the micro-controller 3 of the control device 1 are illustrated separately the one from the other. In the present case, the microcontroller 3 is any micro-controller at will from the family MPC 55xx of Freescale Semiconductor Inc. whose debug interface 5 is based on the Nexus standard.

The debug interface 5 of the control device 1 and the debug interface 6 of the processing unit 2 are at all times outfitted with a trace functionality for the monitoring of monitoring addresses 8a, 8b, 8c, as illustrated in FIGS. 2, 3 and 4.

FIG. 2 illustrates the conventional utilization of the trace functionality to keep track of variable address contents, with the drawback that it entails tracking by way of the trace functionality not only of the monitoring addresses 8a, 8b and 8c of interest, but also the address contents of addresses 9 of no interest. In the case of the trace functionalities of debug interfaces 5, 6 known in prior art, this involves making provision for just one trace address area 10 or just a few trace address areas 10a, 10b. However, when the need is to monitor under these preconditions a plurality of monitoring addresses 8a, 8b, 8c of interest with the trace functionality, and these monitoring addresses 8a, 8b, 8c lie distributed—in other words, not interconnected—in the address space of storage unit 4 of the control device 1, then it is necessary for the one trace address area 10 and/or the few trace address areas 10a, 10b, to be chosen large enough to comprise all monitoring addresses 8a, 8b, 8c of interest. This means, however, that often a plurality of addresses 9 of no interest need to be comprised in the chosen trace address areas 10a, 10b. The trace functionality reacts to changes in the address contents of addresses 9 of no interest in precisely the same way as to changes of address contents of monitoring addresses 8a, 8b, 8c that are of interest. For this reason, in conventional use of the trace functionality illustrated in FIG. 2, often a predominant portion of addresses not belonging to the monitoring addresses 8a, 8b, 8c need to be monitored, which is to say that under the circumstances the degree of utilization of trace functionality is very limited.

In the case of the process according to the invention partly illustrated in FIGS. 3 and 4, a monitoring service not illustrated here on the control device 1 is incorporated for execution with the micro-controller 3 and on the control device 1, provision is made for at least one separate address area 10 within the address space of storage unit 4 with at least one address 11, and there are communicated to the monitoring service—especially divided—monitoring addresses 8a, 8b, 8c within the address space of the storage unit 4 of the control device 1, whereby the monitoring service copies the address contents of the monitoring addresses 8a, 8b, 8c—or just a portion of the monitoring addresses 8a, 8b, 8c—sequentially onto at least one address 11 of the trace address area 10.

By installing a separate trace address area 10, in other words a trace address area 10 located in an unused area of address space and by copying the address contents exclusively of the monitoring addresses 8a, 8b, 8c of interest onto an address 11—or a plurality of addresses 11a, 11b, 11c—of the separate trace address area 10, what is accomplished is that the trace functionality is only indirectly applied to the monitoring addresses 8a, 8b, 8c of interest.

In the schematic illustration of the exemplified embodiment of the invented process in FIGS. 3 and 4, there are communicated to the monitoring service—in other words a supplemental software mounted on control device 1—the monitoring addresses 8a, 8b, 8c within the address space of the storage unit 4 from the processing unit 2 specifically over the debug interface 6 of the processing unit 2, the debug interface 5 of the control device 1 and the connection 7 between the two debug interfaces 5, 6. This enables a wholly flexible observation of differential monitoring addresses 8a, 8b, 8c by way of the invented process on the control device 1. Beyond that, it is also feasible to change the monitoring addresses 8a, 8b, 8c during the running time of an application on the control device I and/or during the execution of an application—or even a plurality of applications—by way of the micro-controller 3 of the control device 1, thereby affording special flexibility.

The process illustrated in FIGS. 3 and 4, based on copying the address contents—notably divided—of monitoring addresses 8a, 8b, 8c onto an address 11 of the trace address area 10, the address contents of the monitoring addresses 8a, 8b, 8c are sequentially, that is to say one after another in time, communicated to the processing unit 2. In any event, a strict sequential transmission is afforded when only one single address 11 of the trace address area 10 is utilized as the trace channel, inasmuch as the monitoring service can of course copy at any time only one address content of a monitoring address 8 onto the address 11 of the trace address area 10. This is made use of in the exemplified embodiments according to FIGS. 3 and 4 in that the monitoring addresses 8a, 8b, 8c of the address content transmitted to the processing unit 2 sequentially by way of the address 11 of the trace address area 10 are detected by the processing limit 2 on the basis of the transmission sequence. To this end it is necessary for the processing unit 2 to know in which sequence the address contents of the monitoring addresses 8a, 8b, 8c of interest are copied by the monitoring service onto the address 11 of the trace address area 10, in other words, in which sequence the address contents of the monitoring addresses 8a, 8b, 8c of interest are transmitted to the processing unit 2 by way of the trace functionality over the debug interfaces 5, 6.

In a further exemplified embodiment not illustrated here, in addition to the address content of a monitoring address 8a, 8b, 8c, the monitoring address 8a, 8b, 8c itself is copied onto an address 11 of the trace address area 10, thereby being made available to the processing unit 2 by the trace functionality over the debug interface 5.

In the exemplified embodiment according to FIG. 4, control instructions for the control of the processing unit 2 are transmitted to the processing unit 2 over the address 11c of the trace address area 10, whereby the control instruction is encoded by the value of the datum so transmitted. In this manner, it is possible in a simple way for the control device I and/or the monitoring service to influence the processing unit 2. In the exemplified embodiment according to FIG. 4, this technique is utilized to communicate to the processing unit 2 the start and the end of the transmission of the address content of at least one monitoring address 8 by way of a control instruction. The control instruction designating the start of the transmissions of the address contents of one monitoring address 8 or a plurality of monitoring address 8a, 8b, 8c is utilized for the purpose of executing the correct allocation of the transmitted address contents to the corresponding monitoring addresses 8a, 8b, 8c on the processing unit 2.

The invented process for the monitoring of a control device 1 on the basis of the modified trace functionality makes it possible to execute observations of the control device 1 not capable of execution with the conventional trace functionality. For example, it is feasible to convert the trace functionality of the “normal” event-driven mode into a time-driven mode, in that the contents of the monitoring addresses 8a, 8b, 8c are sequentially copied within a fixed time frame onto at least one address 11 of the trace address area 10.

In the exemplified embodiments according to FIGS. 3 and 4, to initialize the monitoring process of the control device I by way of the monitoring service, at the outset are first copied all the address contents of the monitoring addresses 8a, 8b, 8c onto an address 11 of the trace address area 10. Consequently, the processing unit 2 also gains knowledge of the original address contents of the monitoring addresses 8a, 8b, 8c, something not feasible in the application of the conventional trace functionality.

In the exemplified embodiment according to FIG. 4, the monitoring service copies the address contents of the monitoring addresses 8a, 8b, 8c, utilized for a variety of tasks implemented on the control device 1, onto the two different addresses 11a, 11b of the trace address area 10. What this means is that the monitoring addresses 8a, 8b, 8c modified by an initial task, and the monitoring address 8c utilized by the second task can be monitored separately the one from the other, in that different trace channels 11a, 11b of the trace address area 10 can be utilized for the transmission of the address contents of the addresses utilized in a plurality of tasks.

1. A process for monitoring a control device comprising:
at least one micro-controller,
at least one storage unit, and
at least one debugging interface,
wherein the storage unit includes address contents in addresses within its address space, the debugging interface is outfitted with a trace functionality for the monitoring of monitor addressed within at least one trace address area inside the address space,
wherein the control device includes a monitoring service for execution with the micro-controller,
wherein the control device includes at least one separate trace address area within the address space with at least one address that the monitoring service receives communication, of divided monitoring addresses within the address space, and that the monitoring service copies at least a portion of monitoring addresses—sequentially onto at least one address of the trace address area.

2. The process according to claim 1,
wherein the processing unit communicates the monitoring addresses within the address space to the monitoring service.

3. The process according to claim 1
wherein the processing unit detects the monitoring addresses of the address contents sequentially transmitted to the processing unit by the address of the trace address area based on the sequence of transmission.

4. The process according to claim 1
wherein the address contents of a monitoring address, and the monitoring address are copied onto an address of the trace channel area.

5. The process according to claim 1
wherein at least one control instruction for the control of the processing unit is transmitted to the processing unit by at least one address of the trace address area wherein the control instruction is encoded by the value of the datum so transmitted.

6. The process according to claim 5,
wherein a control instruction notifies the processing unit of the start of the transmittal of the address content of at least one monitoring address wherein the control instruction designates the start of the transmission of sequentially transmitted address contents of a plurality of monitoring addresses.

7. The process according to claim 1
wherein the monitoring service copies the address contents of the monitoring addresses within a fixed time frame sequentially onto at least one address of the trace address area.

8. The process according to claim 1
wherein the monitoring service upon the request of the processing unit copies the address contents of the monitoring addresses sequentially onto at least one address of the trace address area.

9. The process according to claim 1
wherein the monitoring service copies onto different addresses of the trace address area the address contents of monitoring addresses utilized by a variety of tasks performed on the control device.

10. The process according to claim 5,
wherein a control instruction notifies the processing unit of the end of the transmittal of the address content of at least one monitoring address wherein the control instruction designates the end of the transmission of sequentially transmitted address contents of a plurality of monitoring addresses.

11. The process according to claim 5,
wherein a control instruction notifies the processing unit of the start and end of the transmittal of the address content of at least one monitoring address wherein the control instruction designates the start and end of the transmission of sequentially transmitted address contents of a plurality of monitoring addresses.

12. An apparatus for monitoring a control device comprising:
at least one micro-controller,
at least one storage unit,
at least one debugging interface, and
wherein the storage unit includes address contents in addresses within its address space, the debugging interface includes at least one trace address area
wherein the control device includes at least one separate trace address area within the address space with at least one address

13. An apparatus for monitoring a control device, comprising:
a processor,
a memory, communicatively connected to the processor,
a program stored in the memory, including,
a module to monitor monitor addresses,
a module to perform monitoring services wherein the monitoring service executes with the micro-controller, receives communication of divided monitoring addresses within an address space, and copies at least a portion of monitoring addresses sequentially onto at least one address of a trace address area.

14. A memory for access by a program module to be executed on a processor comprising:
a data structure stored in the memory, wherein the data structure has interrelated data types wherein instruction signals embody data, including,
a data type to store information regarding the monitoring addresses.
